(19) United States
(12) Patent Application Publication
(10) Pub. No.: US 2020/0290862 A1
(43) Pub. Date: Sep. 17, 2020

(54) WINE DISPENSING SYSTEM

(71) Applicant: Joseph P. MADDEN, DesPlaines, IL (US)

(72) Inventor: Joseph P. MADDEN, DesPlaines, IL (US)

(21) Appl. No.: 16/351,263

(22) Filed: Mar. 12, 2019

(51) Int. Cl. B67D 7/80; B67D 7/62

(52) U.S. Cl. CPC B67D 7/80; B67D 7/62

(57) ABSTRACT

A system for dispensing wine at a controlled temperature from a dispensing apparatus. The wine dispensing system includes a tank for holding and storing an intermediate fluid and a multi-tube heat exchanger disposed within the tank. The multi-tube heat exchanger is connected to a source of wine and to the dispensing apparatus. The multi-tube heat exchanger has a Reynolds Number of less than 2500 and a limited volume. An apparatus is provided for constantly monitoring and maintaining the intermediate fluid in the tank at a preselected and generally constant temperature.

### FIELD OF THE INVENTION DISCLOSURE

The present invention disclosure relates to a wine dispensing system for providing wine by the glass.

### BACKGROUND

Restaurants, taverns and other eating establishments typically supplement their menus with various wines. Such offerings not only enhance the appeal of such restaurants, taverns and eating establishments but they can also significantly increase revenue. For various reasons, however, some diners and tavern patrons do not desire to purchase an entire bottle of wine with their meal. Instead, some diners and tavern patrons prefer to supplement their meal with only one or two glasses of wine.

Although the wine being served may be stored at above or below a desired temperature, some wines taste best if served at a specific temperature. That is, some wines may be stored at an ambient temperature but are typically chilled when they are served to patrons. On the other hand, other wines may stored in a refrigerator or the like but taste best when served within a specific temperature range. A sub-cooled wine typically has a longer life expectancy than wine stored at room or an ambient temperature. When wine is stored in kegs at sub-cooled temperatures, however, crystallization may form in the wine. As such, an added filter may be required

The ability to serve a glass or glasses of wine to a customer and at a predetermined temperature to optimize its flavor and taste, however, has proven problematical for many reasons for restaurants, taverns and other eating establishments. Known wine delivery systems offer unsatisfying compromises between pressure loss, flows, beverage working volumes, temperature controls and system sizes. Compromises regarding any one or more of these aspects can result in a less than satisfying performance.

Known wine delivery systems use a single-pass beverage heat exchanger which uses relatively high volumes of beverage in the heat exchanger resulting in high “end” product waste. Alternatively, low volume wine delivery systems have poor temperature controls over the wine being delivered.

Most known wine delivery systems use high pressure carbon-dioxide or mixed gases to drive or otherwise move the wine through the system. As will be appreciated, high pressure losses in these systems results in low flow rates. Moreover, the high pressure carbon dioxide frequently results in carbonization of the wine—a result not appreciated or desired by the customer. Additionally, such known systems can be expensive to install and operate. Moreover, temperature gradients can occur as the wine moves through the line to the tap or point of disbursement.

As such, some establishments use a counter-top (stand alone compressor, evaporator and condenser) system at a serving station. Such known systems are not only bulky by design but they also consume valuable counter space in an already crowded environment.

Alternatively, and in an effort to overcome the bulky space requirements associated with a counter-top system, some establishments have been known to use an under-the-counter bulky keg refrigeration system at the serving station. These known under-the-counter keg refrigeration systems also take precious space at the serving station. Moreover, these known under-the-counter keg refrigeration systems require timely changing of the kegs when they are emptied. This can be a labor intensive effort which can occur at inopportune occasions.

Thus, there continues to be a need and a desire for a wine dispensing system which addresses and solvers the heretofore known problems and challenges associated with known wine delivery systems.

### SUMMARY

In view of the above, and in accordance with one aspect, there is provided a system for dispensing wine at a preselected temperature from a dispensing apparatus having a manifold defining an outlet. According to the first family of embodiments, the wine dispensing system includes a tank for holding and storing an intermediate fluid therein and a multi-tube heat exchanger disposed within the tank. The multi-tube heat exchanger has a Reynolds Number of less than 2500 and a total internal volume of less than ten ounces. The multi-tube heat exchanger has an inlet and an outlet. The system of this invention disclosure further includes an apparatus for constantly monitoring and maintaining the intermediate fluid in the tank at a preselected and substantially constant temperature. The inlet end of the tube of the multi-tube heat exchanger is adapted for releasable connection to a source of wine. The outlet end of the tube of the multi-tube heat exchanger is adapted for releasable connection to a manifold to effect a positive laminar flow between the source of wine and the outlet on the dispensing apparatus.

According to another aspect, there is provided a system for dispensing a plurality of different types of wines at a predetermined temperature from a dispensing apparatus with a manifold having a plurality of independent and separate outlets. In this family of embodiments, the wine dispensing system includes a tank for holding and storing an intermediate fluid therein and a plurality of multi-tube heat exchangers disposed within the tank and through which the wines flow. In this family of embodiment, each multi-tube heat exchanger defines a ratio of about of 0.75 square inches/ounces per minute of wine flowing therethrough. Each multi-tube heat exchanger has a tube with an inlet and an outlet. An apparatus is provided for constantly monitoring and maintaining the intermediate fluid in the tank at a preselected and generally constant temperature. The inlet end of the tube of each multi-tube heat exchanger is adapted for releasable connection to a separate source of wine. The outlet end of the tube of each multi-tube heat exchanger is adapted for releasable connection to the manifold to effect a positive laminar flow between the respective source of wine and one of the outlets on the manifold.

According to yet another aspect of this invention disclosure, there is provided a system for dispensing at least three different types of wines at a preselected temperature from a dispensing apparatus with a manifold having three independent and separate outlets. According to this aspect, the wine dispensing system includes a tank for holding and storing an coolant fluid therein and a series of multi-tube heat exchanger disposed within the tank. In this embodiment, each multi-tube heat exchanger has a Reynolds Number of less than 2500 and a total internal volume of less than ten ounces. Each multi-tube heat exchanger defines a ratio of about 0.75 square inches/ounces per minute of wine flowing therethrough. Each multi-tube heat exchanger has a tube with an inlet and an outlet. An apparatus is provided for constantly monitoring and maintaining the coolant fluid in the tank at a selected and generally constant temperature.

The inlet end of the tube of the first multi-tube heat exchanger is adapted for releasable connection to a first source of wine. The outlet end of the tube of the first multi-tube heat exchanger is adapted for releasable connection to the manifold to effect a positive laminar flow between the first source of wine and a first outlet on the manifold. The inlet end of the tube of the second multi-tube heat exchanger is adapted for releasable connection to a second source of wine. The outlet end of the tube of the second multi-tube heat exchanger is adapted for releasable connection to the manifold to effect a positive laminar flow between the second source of wine and a second outlet on the manifold. The inlet end of the tube of the third multi-tube heat exchanger is adapted for releasable connection to a third source of wine. The outlet end of the third tube of the multi-tube heat exchanger is adapted for releasable connection to the manifold to effect a positive laminar flow between the third source of wine and a third outlet on the manifold.

In each embodiment of the invention disclosure, the intermediate fluid in the tank heats and/or cools the wine to be dispensed from the manifold to a desired temperature so as to optimize the taste of the wine. As such, the source of the wines can be stored at temperature above or below the desired temperature at which the wine is to be dispensed. Accordingly, the present invention disclosure readily and conveniently allows the wine to be stored at room temperature or sub-cooled in a refrigerated storage area.

In each embodiment of the invention disclosure, each multi-tube heat exchanger has relatively small diameter lines arranged in multiple passes relative to each other. The multi-tube heat exchangers advantageously offer a relatively low pressure loss between the inlet and outlet ends of each tube of the heat exchanger. The relatively low pressure loss between the inlet and outlet ends of each tube of the heat exchanger is advantageously accomplished while maintaining satisfactory delivery rates/flow of the wine through the heat exchanger. Each multi-tube heat exchanger of the present invention disclosure offers a relatively high efficiency so as to deliver wine at each of the multiple outlets of the manifold at temperature closely corresponding to the selected temperature of the intermediate fluid in the tank. Moreover, the low internal volume of the of each multi-tube heat exchanger minimizes wasted wine product.

Moreover, the multi-tube heat exchanger preferably uses low pressure gas to positively move the wines through the heat exchanger and to the dispensing apparatus. As such, the likelihood of carbonation of the wine is significantly reduced. Notably, wines typically have a very low carbonation rate, i.e. typically below 10 psi.

Preferably, the apparatus for constantly monitoring and maintaining the intermediate fluid in the tank in each embodiment of the wine dispensing system includes either and/or both an intermittently driven pump and a selectively operated valve operably connected to a system for influencing the intermediate fluid temperature in the tank. In a preferred embodiment, the apparatus for constantly monitoring and maintaining the intermediate fluid in the tank in each embodiment of the wine dispensing system includes a closed-loop controller for maintaining the intermediate fluid in the tank at a preselected and substantially constant temperature. To accomplish there desirous results, the apparatus for constantly monitoring and maintaining the coolant fluid in the tank in each embodiment includes a heater for influencing the temperature of the fluid in the tank.

In a preferred form of this invention disclosure, the wine dispensing system is designed and constructed such that fluid from the tank flows in surrounding relation relative to a portion of each tube extending from the multi-tube heat exchanger to the manifold to further maintain a predetermined temperature for the wine.

### DESCRIPTION OF DRAWINGS

FIG. 1 is a schematic showing of one embodiment of a wine dispensing system embodying principals and teachings of this invention disclosure;

FIG. 2 is a vertical sectional view of some of the components of the wine dispensing system;

FIG. 3 is a perspective view of some of the components of the wine dispensing system;

FIG. 4 is another perspective view of some of the components of the wine dispensing system; and

FIG. 5 is a schematic showing of one form of cooling system operably associated with the wine dispensing system of the present invention disclosure.

### DETAILED DESCRIPTION

While this invention disclosure is susceptible of embodiment in multiple forms, there is shown in the drawings and will hereinafter be described a preferred embodiment, with the understanding the present disclosure is to be considered as setting forth an exemplification of the disclosure which is not intended to limit the disclosure to the specific embodiment illustrated and described.

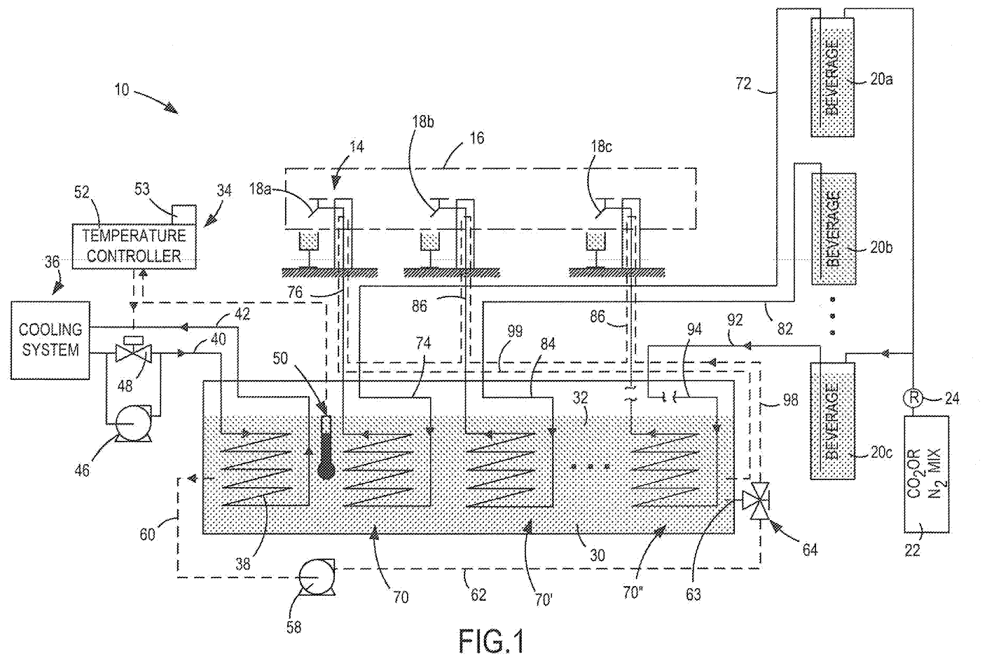

Referring now to the drawings, wherein like reference numerals indicate like parts throughout the several views, there is schematically shown in FIG. 1 the major components of a system, generally indicated by reference numeral 10, which, in one embodiment, dispenses different types or varieties of wine. In the illustrated embodiment, the wine dispensing system 10 is designed and is capable of dispensing multiple types or varieties of wine from a beverage tower or dispensing apparatus 14 equipped with a manifold 16 having a plurality of independent and separate outlets 18a, 18b and 18c. While the drawings schematically illustrate a system capable of dispensing three different types or varieties of wines, it should be appreciated the teachings and principals of this invention disclosure equally apply to an system capable of dispensing lesser or more types or varieties of wines without detracting or departing from the true spirt and novel scope of this invention disclosure.

In the embodiment illustrated by way of example in FIG. 1, the wine dispensing system 10 is arranged in operable combination with three different wine sources 20a, 20b, 20c. Each wine source 20a, 20b and 20c preferably contains a different type or variety of wine then the other. The wine in each container 20a, 20b and 20c is maintained under pressure by a suitable and well known pressuring source 22 which is suitably connected to each container 20a, 20b and 20c to effect a positive laminar flow of wine between each source 20a, 20b and 20c and the manifold 16 on beverage tower 14. In the illustrated embodiment, a pressurized gas, i.e. carbon-dioxide or carbon/nitrate dioxide mix, is connected to each container 20a, 20b and 20c as through a regulator 24 which controls and/or regulates the level of pressure in each container 20a, 20b and 20c. Preferably, and to avoid carbonization of the wine in each container 20a, 20b and 20c, the regulator 24 maintains the source of pressure to each container at less than 10 psi. while creating and maintaining a positive laminar flow of wine between the source 20a, 20b and 20c and the respective outlet 18a, 18b and 18c.

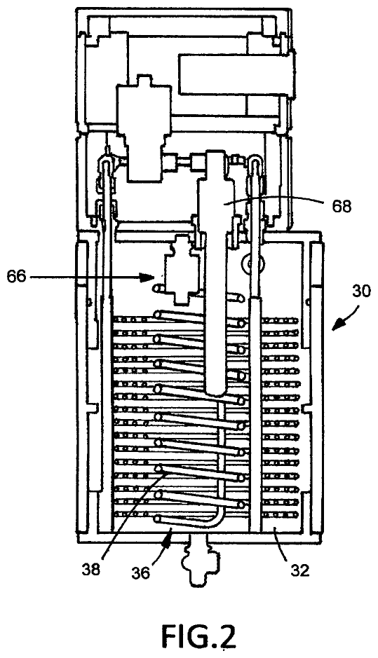

As shown in FIGS. 1 and 2, a tank 30 is provided as part of system 10. Tank 30 is configured to hold an intermediate fluid, generally indicated by reference numeral 32 in FIG. 1, therewithin. In one form, the intermediate fluid 32 is either water or a water/glycol mixture. Moreover, the average temperature of the intermediate fluid 32 is regulated by an closed-loop apparatus, generally indicated in FIG. 1 by reference numeral 34. In a preferred embodiment, the tank 30 is designed and sized to fit on a flat counter adjacent to a serving station at a restaurant or other eating establishment and is portable.

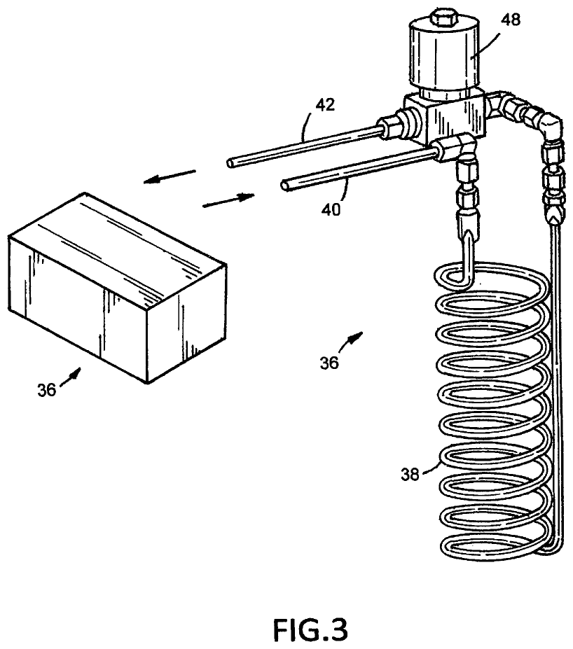

Apparatus 34 includes those components for maintaining the intermediate fluid 32 at a preselected and substantially constant temperature. To effect these ends, a glycol system, generally indicated in FIGS. 1 and 3 by reference numeral 36, is provided for influencing the temperature of the intermediate fluid 32 in the tank 30. In one embodiment, system 36 includes a spiral coil 38 which, in the preferred embodiment, is completely submerged in tank 30 such that the intermediate or cooling fluid 32 in tank 30 can freely move therabout. Coil 38 has an inlet line 40 suitably connected to and adapted to receive fluid from a glycol tank 42 and a return line 44 which, after passing through coil 38, returns glycol fluid to tank 30. Preferably, an intermittently driven pump 46 and/or a selectively operated valve 48 effectively and efficiently moves glycol fluid through the system 36 and facilitates maintaining the temperature of the fluid in the tank 30 at a preselected and substantially constant temperature.

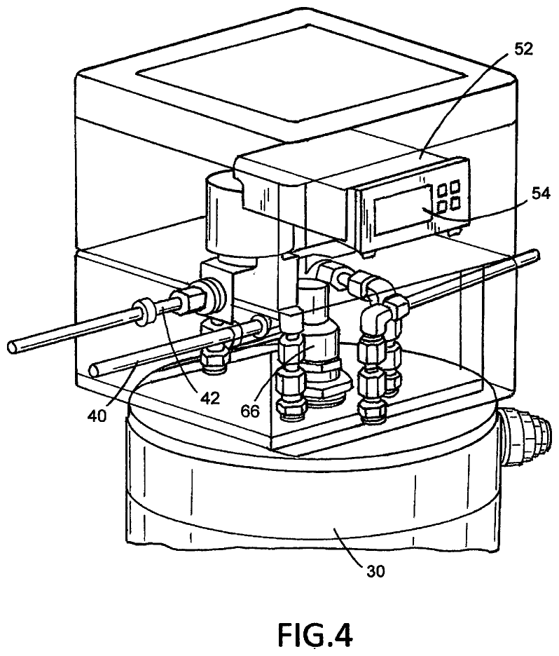

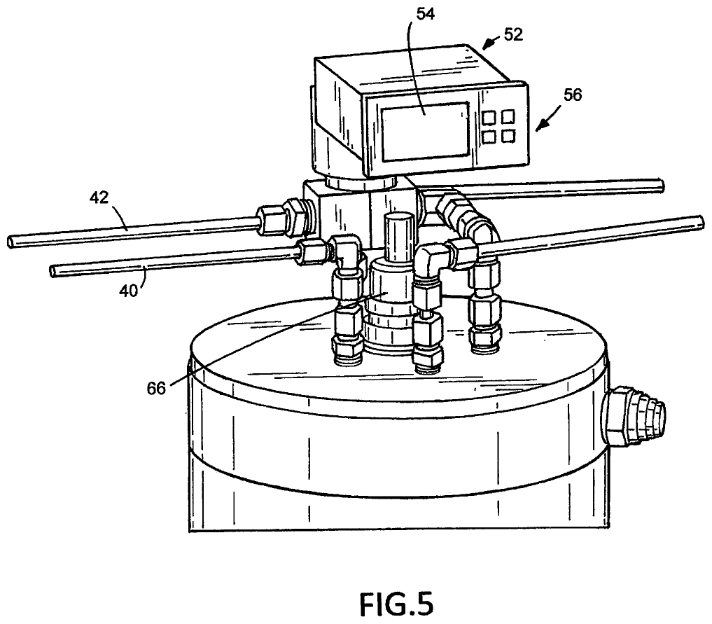

So as to maintain the intermediate fluid 32 in tank 30 at a desired and/or selected temperature, apparatus 34 furthermore preferably includes a sensor or temperature probe 50 for continually monitoring the average temperature of the fluid 32 in tank 30. As schematically illustrated in FIG. 1, the senor or temperature probe 50 is operably connected to a closed-loop temperature controller 52. The temperature controller 52 preferably includes a micro-processor 53 which is responsive to temperature signals from probe 50 and operates to control the average temperature of the intermediate fluid 32 in tank 30 based on the temperature signals received from sensor 50. In a preferred embodiment, the temperature controller 52 includes a visible indicator or read-out 54 (FIGS. 2 and 4) for visually indicating the average temperature of the intermediate fluid 32 in tank 30. Notably, the temperature controller 52 also includes manually an adjustable device 56 (FIG. 5) operably connected to the micro-processor 53 for adjusting (up or down) the average temperature of the fluid 32 in tank 30.

In the embodiment illustrated by way of example in FIG. 1, the temperature controller 52 is operably connected to and , in one form, intermittently operates the pump 46 and/or controls valve 48 of the cooling system 36 as a function of the temperature indicative signals sent by the sensor or temperature probe 50 and received by the temperature controller 52 whereby regulating and maintaining the average temperature of the intermediate fluid 32 at the temperature selected through use of the adjustable device 56. That is, the flow of fluid through the cooling system 36 is regulated by operation of the pump 48 and valve 49 as a function of signals from the temperature controller 52.

In the embodiment illustrated by way of example in FIG. 1, apparatus 36 furthermore includes a recirculation pump 58 for creating a continuous flow of intermediate fluid 32 in and through the tank 30 whereby improving heat convection while facilitating an even average temperature for the intermediate fluid 32 in tank 30. This results in improved temperature control of the wine. In the embodiment illustrated in FIG. 1, a drain line 60 leads from tank 30 to an input side of the secondary pump 58. An output line 62 leads from the outlet side of the pump 58 to an inlet 63 in the tank 30. A bypass or balance valve 64 is preferably provided in the output line 62.

Applicant recognizes and appreciates the wine sources, in whatever number and for whatever reason, can be stored in a sub-cooled environment. Accordingly, and to significantly enhance the versatility of the present invention disclosure by being able to dispense wines at a desired temperature, even though the wine may be stored in a sub-cooled situation or environment, apparatus 34 furthermore preferably includes a heater 66 (FIGS. 2 and 4). In one form, heater 66 includes a suitable electrically operated warming element 68 mounted on tank 60 and which extends into the fluid 32 in tank 30 so as to warm or otherwise influence the temperature of the intermediate fluid 32. As will be appreciated, operation of the warming element 68 is controlled as a function of signals delivered to controller 52 by probe 50.

In the embodiment illustrated by way of example in FIG. 1, the wine dispensing system 10 furthermore includes a plurality of multi-tube heat exchangers 70, 70′ and 70″ submerged within the tank 30 for maximizing heat transfer efficiency. Preferably, and to reduce manufacturing costs of system10, the heat exchangers 70, 70′ and 70″ are substantially identical in construction and purpose relative to each other. Each multi-tube heat exchanger has relatively small diameter and continuous lines arranged in multi-parallel passes or coils relative to each other to significantly increase surface area of the heat exchanger and thereby improve heat convection while minimizing the space constrains thereof Preferably, each multi-tube heat exchanger has a low internal volume whereby minimizing product “end” waste. In one form, each multi-tube heat exchanger has a volume of less than about ten ounces. Preferably, each multi-tube heat exchanger has Reynolds Number of less than 2500. In another form, each multi-tube heat exchanger defines a ratio of about 0.75 square inches/ounces of wine per minute flowing therethrough. Another distinct advantage of the multi-tube heat exchanger being that in minimizes pressure loss between inlet and outlet end thereof.

In the embodiment illustrated by way of example in FIG. 1, the multi-tube heat exchanger 70 has a tube or conduit 72 with an inlet 74 and an outet 76. The inlet 74 to the tube 72 of the multi-tube heat exchanger 70 is operably connected to the first source 20a of wine. The outlet 76 for the first tube 72 of the multi-tube heat exchanger 70 is operably connected to the manifold 16 to effect a positive laminar flow of temperature controlled wine between the first wine source 20a and the first outlet 18a on the manifold 16.

In the embodiment illustrated by way of example in FIG. 1, the multi-tube heat exchanger 70′ has a tube or conduit 82 with an inlet 84 and an outlet 86. The inlet 84 to tube 82 of the multi-tube heat exchanger 70′ is operably connected to the second source 20b of wine. The outlet 86 for the tube 82 of the multi-tube heat exchanger 70′ is operably connected to the manifold 16 to effect a positive laminar flow of temperature controlled wine between the second wine source 20b and the second outlet 18b on the manifold 16.

In the embodiment illustrated by way of example in FIG. 1, the multi-tube heat exchanger 70″ has a tube or conduit 92 with an inlet 94 and an outlet 96. The inlet 94 to tube 82 of the multi-tube heat exchanger 70″ is operably connected to the third source 20c of wine. The outlet 96 for the tube 92 of the multi-tube heat exchanger 70″ is operably connected to the manifold 16 to effect a positive laminar flow of temperature controlled wine between the second wine source 20b and the second outlet 18b on the manifold 16.

Applicant recognizes there may be situations where the tank 30 is disposed away from the dispensing apparatus 14 whereby leading to lengthier tubes leading from the multi-tube heat exchangers 70, 70′ and 70″ to the dispensing apparatus 14. As such, and as schematically illustrated in FIG. 1, to maintain control over the temperature of the wine being dispensed from the any one of the outlets 18a, 18b or 18c, a lengthwise portion of each tube or conduit leading from the respective heat exchanger to the dispensing apparatus 14 preferably has an inlet trunk line 98 and a return trunk line 99 arranged in generally parallel relation relative thereto for at least a portion of the length thereof. The inlet trunk line 98 receives intermediate tank fluid 32 from the outlet of the secondary pump 58 and through a selectively operated valve 64.

As schematically shown in FIG. 1, intermediate fluid flows through the trunk line 98 about at least a portion of the output line or conduit leading from each of the tubes of the multi-tube heat exchanger 70 and is returned via the return trunk line 99 to the tank 30 for subsequent mixing with the remainder of the intermediate fluid 32 in tank 30. As such, and regardless of the distance the multi-tuber heat exchanger is disposed from the dispensing apparatus 14, a relatively constant predetermined temperature is maintained for the wine being dispensed from apparatus 14.

From the foregoing, it will be observed that numerous modifications and variations can be made and effected without departing or detracting from the true spirit and novel concept of this invention disclosure. Moreover, it will be appreciated, the present disclosure is intended to set forth an exemplification which is not intended to limit the disclosure to the specific embodiment illustrated. Rather, this disclosure is intended to cover by the appended claims all such modifications and variations as fall within the spirit and scope of the claims.

What is claimed is:

1. A system for dispensing wine at a preselected temperature from a dispensing apparatus having a manifold defining an outlet, said wine dispensing system comprising:
a tank for holding and storing an intermediate fluid therein;
a multi-tube heat exchanger disposed within said tank, said multi-tube heat exchanger having a Reynolds Number of less than 2500 and a total internal volume of less than ten ounces, with said multi-tube heat exchanger defining a tube having an inlet end and an outlet end;
an apparatus for constantly monitoring and maintaining said intermediate fluid in said tank at a preselected and substantially constant temperature; and
with the inlet end of said tube of said multi-tube heat exchanger being adapted for releasable connection to a source of wine, and with the outlet end of said first tube of said multi-tube heat exchanger being adapted for releasable connection to said manifold to effect a positive laminar flow between said source of wine and the outlet of said dispensing apparatus.

2. The wine dispensing system according to claim 1, wherein said apparatus for constantly monitoring and maintaining said intermediate fluid in said tank includes one of an intermittently operated pump and a selectively operated valve connected to and controlled by a system for influencing the intermediate fluid temperature in said tank.

3. The wine dispensing system according to claim 1, wherein said apparatus for constantly monitoring and maintaining said intermediate fluid in said tank includes a closed-loop controller for maintaining the intermediate fluid in said tank at the preselected and substantially constant temperature.

4. The wine dispensing system according to claim 1, wherein said apparatus for constantly monitoring and maintaining said intermediate fluid in said tank includes a heater for influencing the temperature of the intermediate fluid in said tank.

5. The wine dispensing system according to claim 1, further including a trunk line arranged in surrounding relation relative to a portion of said tube extending from said heat exchanger to said manifold, with said trunk line receiving fluid from said tank such that the intermediate fluid in said trunk line maintains the wine therein at the preselected and substantially constant temperature.

6. A system for dispensing a plurality of different types of wines at a predetermined temperature from a dispensing apparatus with a manifold having a plurality of independent and separate outlets, said wine dispensing system comprising:
a tank for holding and storing an intermediate fluid therein;
a plurality of multi-tube heat exchangers disposed within said tank and through which the wines flow, with each multi-tube heat exchanger defining a ratio of about 0.75 square inches/ounces per minute of wine flowing therethrough, and with each multi-tube heat exchanger defining a tube having an inlet and an outlet;
an apparatus for constantly monitoring and maintaining said intermediate fluid in said tank at a preselected and substantially constant temperature;
with the inlet end of the tube of each multi-tube heat exchanger being adapted for releasable connection to a source of wine, and with the outlet end of the tube of each multi-tube heat exchanger being adapted for releasable connection to said manifold to effect a positive laminar flow between the respective source of wine and one of said outlets on said manifold.

7. The wine dispensing system according to claim 6, wherein said apparatus for constantly monitoring and maintaining said intermediate fluid in said tank includes one of a intermittently driven pump and a selectively operated valve connected to a system for influencing the intermediate fluid temperature in said tank.

8. The wine dispensing system according to claim 6, wherein said apparatus for constantly monitoring and maintaining said coolant fluid in said tank includes a closed-loop controller for maintaining the fluid in said tank at a substantially constant temperature.

9. The wine dispensing system according to claim 6, wherein said apparatus for constantly monitoring and maintaining said intermediate fluid in said tank includes a heater for influencing the temperature of the intermediate fluid in said tank.

10. The wine dispensing system according to claim 6, further including a pressurized source of gas for effecting the positive laminar flow of wine between said source of wine and said manifold.

11. The wine dispensing system according to claim 6, wherein each multi-tube heat exchanger is operably connected to a pressurized gas source.

12. The wine dispensing system according to claim 11, wherein said pressurized source of gas is pressurized at less than about 10 psi.

13. The wine dispensing system according to claim 6, further including a trunk line arranged in surrounding relation relative to a portion of each tube extending from said multi-tube heat exchangers to said manifold, with said trunk line receiving fluid from said tank such that the intermediate fluid in said trunk line maintains the wine therein at the preselected and substantially constant temperature.

14. A system for dispensing at least three different types of wines at a preselected temperature from a dispensing apparatus with a manifold having three independent and separate outlets, said wind dispensing system comprising:
a tank for holding and storing a coolant fluid;
a series of multi-tube heat exchangers disposed within said tank, with each multi-tube heat exchanger having a Reynolds Number of less than 2500 and a total internal volume of less than ten ounces, and with each multi-tube heat exchanger defining a ratio of about 0.75 square inches/ounces per minute of wine flowing therethrough, and wherein each multi-tube heat exchanger includes a first tube having an inlet and an outlet;
an apparatus for constantly monitoring and maintaining said coolant fluid in said tank at a selected constant temperature;
with the inlet end of the tube of a first multi-tube heat exchanger being adapted for releasable connection to a first source of wine, and with the outlet end of the tube of said first multi-tube heat exchanger being adapted for releasable connection to said manifold to effect a positive laminar flow between said first source of wine and a first outlet on said manifold;
with the inlet end of the tube of a second multi-tube heat exchanger being adapted for releasable connection to a second source of wine, and with the outlet end of the tube of said second multi-tube heat exchanger being adapted for releasable connection to said manifold to effect a positive laminar flow between said second source of wine and a second outlet on said manifold; and
with the inlet end of said the tube of a third multi-tube heat exchanger being adapted for releasable connection to a third source of wine, and with the outlet end of the tube of said third multi-tube heat exchanger being adapted for releasable connection to said manifold to effect a positive laminar flow between said third source of wine and a third outlet on said manifold.

15. The wine dispensing system according to claim 14, wherein said apparatus for constantly monitoring and maintaining said cooling fluid in said tank includes one of an intermittently operated pump and a selectively operated valve connected to a system for influencing the cooling fluid temperature in said tank.

16. The wine dispensing system according to claim 14, wherein said apparatus for constantly monitoring and maintaining said intermediate fluid in said tank includes a closed-loop controller

17. The wine dispensing system according to claim 14, wherein said apparatus for constantly monitoring and maintaining said coolant fluid in said tank includes a heater for influencing the temperature of the fluid in said tank.

18. The wine dispensing system according to claim 14, further including a pressurized source of gas for effecting a positive laminar flow of wine between said sources of wine and said manifold.

19. The wine dispensing system according to claim 18, wherein said source of gas is pressurized at less than about 10 psi.

20. The wine dispensing system according to claim 14, wherein the intermediate fluid from said tank flows in surrounding relation relative to a portion of each tube extending from each multi-tube heat exchanger to said manifold to further maintain a predetermined temperature for said wines.
